(19) United States
(12) Patent Application Publication
(10) Pub. No.: US 2004/0239823 A1
(43) Pub. Date: Dec. 2, 2004

(54) Display

(76) Inventors: Paul Alistair Silsby, West Sussex (GB); Mark Aston, Kent (GB)

Correspondence Address: NIXON & VANDERHYE, PC, 1100 N GLEBE ROAD, 8TH FLOOR, ARLINGTON, VA, 22201-4714, US

(21) Appl. No.: 10/486,643

(22) PCT Filed: Aug. 13, 2002
(86) PCT No.: PCT/GB02/03764

(30) Foreign Application Priority Data
Aug. 13, 2001 (GB) 0119707.8

(51) Int. Cl. G02F 1/1333

(52) U.S. Cl. 349/40

(57) ABSTRACT

The technique of the present invention improves the viewability of a large display screen by using an antiglare screen arranged over a plurality of pixels. The anti-glare consists of a plurality of anti-glare elements (17) which have a surface facing the position from which the display is viewable (18). Each anti-glare element surface (18) is of substantially parabolic shape in order to effectively disperse light that is incident on the display screen.

This invention relates to a display and, in particular, to a liquid crystal display (LCD) device for displaying a moving image or such like on a large, e.g. outdoor, screen.

Large screen displays or video screens are used for a variety of applications. For example, screens may be installed in sports stadiums to show video and television pictures or images, or appropriate information such as match or event statistics, e.g. a football score. Large screen displays might also be employed at outdoor events such as rock concerts or festivals to display moving pictures to large audiences. Screens may be temporarily rigged on a stage or mounted on a truck for example. It is also fairly common to see large screen displays used as advertising hoardings or billboards.

Such displays use a number of different technologies. In some circumstances, it is possible to use projection to display images onto a large screen, e.g. in the same way as at a cinema or movie theatre. However, there is a limit to the brightness of projector lamps, with the consequence that projection can only be used inside, or outside where ambient lighting conditions are dim, e.g. at dusk or at night. It is also possible to construct large screen displays from arrays of conventional television monitors, e.g. cathode ray tubes, which screens are sometimes referred to as “video walls”. However, such screens are again not very bright and hard to view in bright ambient lighting conditions, e.g. outside. Furthermore, there are inevitably gaps between the television monitors of the array and this significantly detracts from the overall appearance and picture quality of the screen.

One way of more effectively displaying large moving images outside during the day is to use a screen comprising an array of incandescent bulbs. A lamp screen can have a large number of white light incandescent bulbs that shine through red, green and blue filters. The brightness of the bulbs is modulated to produce an image. In other words, three bulbs shining through a red, green or blue filter respectively make up a pixel of a display and plural such pixels produce an image. This is analogous to the way in which the red, green and blue light emitted from a cathode ray tube produces an image, e.g. in a television or computer monitor. Lamp screens can be quite bright, and can therefore be viewable outside during the day. However, they have several disadvantages. For example, the resolution of lamp screens tends to be very low as it is difficult to fit a large number of bulbs into a small area. They also: tend to consume a large amount of electricity and get very hot as incandescent bulbs are not very efficient; require a large amount of maintenance to replace blown bulbs; and have difficulty in displaying quickly moving or frequently refreshed pictures as the bulbs can only change brightness relatively slowly. They also display images with poor contrast and saturated colours and still therefore have difficulty in displaying images in bright ambient lighting conditions.

Lamp screens were improved with the advent of cathodoluminescent bulbs. Cathodoluminescent lamp displays comprise an array of red, green and blue cathodoluminescent bulbs, which are similar to flat vacuum florescent tubes each having a single, appropriately coloured phosphor. These bulbs are smaller and can be turned on and off more quickly than incandescent bulbs, such that cathodoluminescent displays have better picture quality than incandescent lamp displays. However, these screens are very expensive and still have heat dissipation, power consumption, maintenance and brightness problems. They are also very heavy, which makes installation difficult.

The advent of light emitting diodes (LED's) and, in particular, blue LED's (which were more difficult to develop) led to the development of LED screens, which work in much the same way as lamp screens. A red, green and blue LED make up a pixel and a large array of such pixels make up the screen. Moving images are displayed by switching the electrical supply to the LED's such that they shine at different brightness and display an image. Generally, the brightness of an LED can be altered more quickly than that of a lamp and this improves picture quality. Also, more LED's than bulbs can generally be fitted into a given area of a screen, which improves image resolution. However, good quality LED's, and hence LED screens, are relatively expensive. Furthermore, replacement of broken LED's can be difficult, making maintenance time consuming and expensive. Heat dissipation can also be difficult as it is necessary to mount the LED's close together to attain good picture quality.

It has also been suggested to use liquid crystals for large screen displays. Conventional Liquid Crystal Display (LCD) screens are generally only relatively small and find use as computer monitors and such like. They usually comprise an array of Twisted Nematic (TN) liquid crystal elements or pixels that can be controlled to vary in opacity according to the strength of the electric field applied to them. A relatively wide variation of opacity can be achieved, providing effective display of images as the brightness of light transmitted by the elements is varied. However, TN liquid crystals remain fairly opaque, even when controlled to be as transparent as possible and TN LCD's therefore tend to be quite dim. The optical properties of TN liquid crystals also result in it only being possible to view TN LCD's from a fairly narrow range of viewing angles. Whilst this may be acceptable for computer monitors and such like, it is very impractical for large screen displays. The narrow viewing angle can be mitigated to some extent by thin film transistor (TFT) super-twist LCD displays, but these are very expensive and thus also impractical for large screen displays. Thus, although it is possible to make large screen displays using liquid crystals (e.g. by building an array of smaller screens), such screens are exceptionally expensive, dim and generally viewable from only narrow viewing angles.

When viewed from a first aspect the present invention provides a display screen comprising a plurality of pixels and an anti-glare screen arranged over the pixels comprising anti-glare elements having a surface facing the position from which the display is viewable, which surface is curved to disperse light incident on the screen.

Thus in accordance with the invention the problem occurring with prior art displays whereby ambient lighting conditions significantly deteriorate viewing, for example when direct sunlight is reflected off the front of the screen, may be alleviated.

Preferably the surface is curved on a line by line basis one pixel high, so as not to distort the image. Elements may be provided over each, or groups of, pixel(s). The surface may be concave or convex. In some preferred embodiments the surface to have the shape of a section of the circumference of an ellipse. More specifically, the surface may follow

$$y = √ ( ( 1 - \frac{{x}^{2}}{{a}^{2}} ) {b}^{2} )$$

where x is a direction in the plane of the screen, y is a direction out of the plane of the screen, a is approximately 20 and b is approximately 4. However this is not essential and, in general, any conic section profile is preferred. The surface may also be oriented downward in use.

When viewed from another aspect the invention provides a display screen comprising an array of pixels for displaying an image, wherein the pixels comprise liquid crystal elements divided into segments and the brightness of light passing through a respective pixel can be varied by controlling the number of segments of liquid crystal that are substantially transparent or substantially opaque.

Also according to the present invention, there is provided a method of displaying an image on a screen comprising an array of pixels comprising liquid crystal elements divided into segments, the method comprising varying the brightness of light passing through respective pixels by controlling the number of segments of liquid crystal that are substantially transparent or substantially opaque.

In other words, the screen has pixels of liquid crystal adapted to be varied in brightness by varying the number of segments of liquid crystal of the pixels that transmit light. Each segment of liquid crystal is switchable between two states, a first state in which it transmits substantially all visible light and a second state in which it transmits substantially no visible light. The pixels and, in particular, the segments of liquid crystal, are small in relation to the screen, such that it is virtually imperceptible to a viewer which segments are transparent and which are opaque, other than that the pixels vary in brightness and display an image.

Liquid crystals that are only switched between two states can generally be designed to transmit light over wide viewing angles far more efficiently than liquid crystals that can be switched between multiple degrees of opacity. Thus, the screen of the invention can transmit a larger amount of light over a wider viewing angle than LCD's of the prior art. This is very important for large, outdoor displays as these must be viewable from large distances and a large range of locations in bright ambient light conditions, e.g. in a sports stadium during the day.

The display of the present invention is also significantly cheaper to manufacture and more reliable than LCD's of the prior art as liquid crystal elements that are switchable between only two states are cheaper to manufacture and more reliable. Also, to switch the segments of liquid crystal elements between two states, the control circuitry only needs to apply-two different, distinct voltages across the liquid crystal, whereas, in the prior art, critical tolerances are required to ensure that all the pixels of an LCD can be consistently controlled between the various required states. The control circuitry is therefore cheaper and more reliable than that of the prior art.

Various types of liquid crystal can be used to construct the liquid crystal elements. However, in a particularly preferred embodiment, the liquid crystal is Helmeier type liquid crystal. The liquid crystal elements are therefore Helmeier type liquid crystal elements.

This is also considered to be new and, according to another aspect of the invention, there is therefore provided a display screen comprising pixels of Helmeier liquid crystal for modulating the brightness of light passing through the screen to display an image. In at least preferred embodiments, the display pixels are made up of a combination of unique components which, when selected electronically, produce the necessary levels of luminance, hue and saturation for a video image at up to 25 frames (images) a second.

There is also provided a method of displaying an image on a screen comprising modulating the brightness of light passing through the screen by altering the state of pixels of Helmeier type liquid crystal.

Helmeier liquid crystal elements may comprise a linear polariser and a nematic liquid that hosts a pleochroic or Azo dye. The nematic liquid and dye may be arranged, in their natural state, not to transmit light polarised in the direction of the linear polariser. This may be achieved by the polarising effect of the nematic liquid and dye being oriented at 90° to the direction of that of the linear polariser. Thus, when the element is in its natural state, no light is transmitted. However, electrodes may be arranged across the nematic liquid such that a voltage can be applied to (segments of) the nematic liquid. When a voltage is applied to the nematic liquid, the orientation of molecules of the liquid align with the electric field. This, in turn, causes the molecules of the dye to be re-oriented such that their polarising effect is changed or effectively turned off. Light is therefore transmitted by the liquid crystal element.

The use of Helmeier type liquid crystal elements is particularly advantageous as, when the electric field is applied to the element, the polarising effect of the pleochroic dye can be almost completely turned off. Helmeier liquid crystal elements can thus be arranged to be highly transmissive in their “on” state. This is very useful for large, e.g. outdoor, display screens, which must be as bright and have as high contrast as possible.

As understood by the skilled man, pixels (short for picture elements) are tiny elements of a screen that vary in brightness (and colour where appropriate) to display an image. In this example, the pixels may be selected from a range of particular sizes e.g. nominally 7.5 mm, 15 mm, 30 mm and 50 mm square so as to provide a range of display sizes with the necessary pixel resolution (quantity) to display an image of good quality. The screen may have a total area of approximately 3 m² to 120 m². Pixels are generally identical to one another, but have an appearance that can be varied (i.e. in brightness) to produce an image.

Colour pictures are usually displayed by pixels made up of red, green and blue light components. By varying the relative brightness of the red, green and blue light, both the colour and overall brightness of the pixel may be varied to display an image. The display of the present invention may therefore comprise pixels having red, green and blue colour elements. In preferred embodiments each colour element has up to eight segments configured so as to modulate the light in increments necessary to generate a video image. For example, the display may have a white light source and pixels may have red, green and blue filters. The filters may be provided over groups of segments of the liquid crystal element of a pixel such that the brightness of each colour may be varied. In other words, each pixel may be arranged such that the segments can modulate the amount of red, green and blue light passing through the pixel separately, e.g. by having colour filters over groups of segments. Thus, the colour of a pixel can be varied to display a colour image.

As is clear from the above, it is important to maximise the brightness and contrast of display screens, particularly for large, outdoor applications. The white light source preferably comprises lamps that use high colour rendering phosphors that have emission peaks in the red, green and blue parts of the emission spectrum. In particular, this is usual for fluorescent lights preferred in the present invention. The colour filters may therefore be selected to transmit strongly at the emission peaks of the white light source. Likewise, the dye of the liquid crystal may be selected to absorb strongly at the emission peaks of the white light source.

This is considered to be new in itself and, according to another aspect of the present invention, there is therefore provided a display comprising: a white light source; a screen having pixels for modulating the brightness of light emitted by the light source; and filters for altering the colour of light transmitted by each pixel, wherein the filters have a band of strongest transmission at a wavelength substantially equal to an emission peak of the light source. A dye provided in the pixels may also be selected to absorb strongly at emission peaks of the light—source. The transmission of light from the light source can thus be maximised. The brightness and contrast of the screen can also be maximised.

The pixels or, more specifically, the segments of the liquid crystal elements, may be arranged to modulate light transmitted by a pixel as desired. However, it is preferred that the total or sum surface area of the segments of an element in each of the first and second states can be varied to modulate the amount of light passing through the pixel. The surface areas of the segments may thus be arranged in a convenient manner to achieve this. In particular, the surface areas of the segments may be related, or increase with respect to one another, by powers of 2.

This is considered to be novel in itself and, according to another aspect of the present invention there is therefore provided a pixel for a liquid crystal display comprising plural discrete segments of liquid crystal having surface areas effective for modulating the transmission of light, the size of which are related powers of 2.

Also according to the present invention there is provided a method of modulating the transmission of light through a pixel of the liquid crystal display, the method comprising changing the state of plural discrete segments of the liquid crystal of the pixel, which segments have surface areas effective for modulating the transmission of light, the size of which are related by powers of 2.

This is particularly effective as it allows binary scaling of the surface area of the pixel that transmits light. In other words, having N (i.e. an integer, e.g. 5) segments of liquid crystal, the surface areas of which increase with respect to one another by a power of two (i.e. each of which is twice the size of the next smallest) allows 2^{N} (e.g. 32) different sizes of surface area of liquid crystal to be say switched on or in one of the first or second states at any one time.

In particular, it is preferred that the sizes of the effective surface area of the segments increase with respect to one another from 2^{N} to 2^{N-1}, where N is the number of segments. It is also preferred that the segments are arranged concentrically. This means that, from a distance, the light transmitted by an element is effectively a point source, i.e. is transmitted from a single point, regardless of which segments are transmitting the light. This prevents flicker or picture distortion as the brightness of the pixels is varied to display a picture. The size of the surface areas of the cells may increase toward the periphery of the pixel.

In addition to the above-described segment area greyscale reproduction, the on and off time of pixel segments per second i.e. the relative periods of on and off, may be varied to increase the effective number of greyscale levels achievable by the system. Preferably therefore the display comprises means for varying the relative on and off periods of the pixel segments. The relative proportion of time that a pixel is able to transmit light gives additional control over the number of grey levels between black and white that can be achieved. The stability of the modulation need not be in question since there are relatively few steps to be accommodated which reduces switching problems—normally solved by TFT technology. The Applicants have appreciated the combination of the area greyscale achieved in accordance with the earlier aspect of the invention by controlling the number of segments which are on or off with the on-off modulation described above, gives a significantly improved overall image quality e.g. over using such on-off modulation alone in Helmeier cells. The use of area greyscale in conjunction with modulation of the on off time per second to increase the number of greyscale steps available is considered novel and inventive in its own right and thus when viewed from a further aspect the invention provides a display screen comprising an array of pixels for displaying an image, wherein the pixels comprise liquid crystal elements divided into segments, the screen being arranged to control the brightness of light passing through a respective pixel by controlling the number of segments of liquid crystal that are substantially transparent or substantially opaque and the relative periods during which each segment is substantially transparent or substantially opaque.

The physical design of the display may vary according to the requirements of a particular location. However, modular design is particularly convenient as it allows easy access for maintenance and such like. In preferred embodiments the display comprises a plurality of pixel modules arranged such that the mutual spacing between said pixels is substantially constant so as to give a substantially seamless image.

According to another aspect of the invention, there is provided a liquid crystal display illuminated from the rear, the illumination comprising a plurality of tubular light sources inclined along their length to the plane of the liquid crystal display. The angle of inclination may be about 8°. This allows connection to the tubular light sources or fluorescent tubes to be accessed without dismantling the screen.

The liquid crystal elements must generally be kept at a temperature of around 10° C. to 35° C. The central body of the light sources must generally be kept at a temperature of between around 75° C. and 95° C. whilst the tip temperature is normally some 10° C. lower. According to another aspect of the present invention there is therefore provided a temperature management system for a display comprising means for supplying air to liquid crystal elements of the display, wherein the air exits over light sources of the display. Thus, the temperature of the different parts of the display can be maintained at the desired level using a single air cooling system.

In particular, it has been found that providing air orifices around the liquid crystal elements having surface areas of around 40 mm² and supplying air at a flow rate of between 0.6 and 1.1 cubic metres per second maintains the liquid crystal elements and light sources at the desired temperatures.

Finally, in order to maximise the brightness of the screen, it is desirable to reflect as much light emitted from the light sources as possible through the screen. It is also desired to do this in a manner that provides an even light, such that the use of diffusers can be avoided. Tubular light sources and, in particular, a fluorescent tube shaped in a U-shape, such that two parallel tubular light sources are provided by each lamp are preferred. Such lamps are generally supplied with particular dimensions and, in particular have a specified gap between each tube. This light must be reflected evenly through pixels of given dimensions.

According to another aspect of the present invention, there is therefore provided a reflector for a lamp comprising two adjacent light sources, the reflector having a first arc of curvature along the base from the sidewall and a second arc of curvature along the base from a position intermediate to the light sources in use.

Embodiments of the present invention will now be described, by way of example only, with reference to the accompanying drawings, in which:

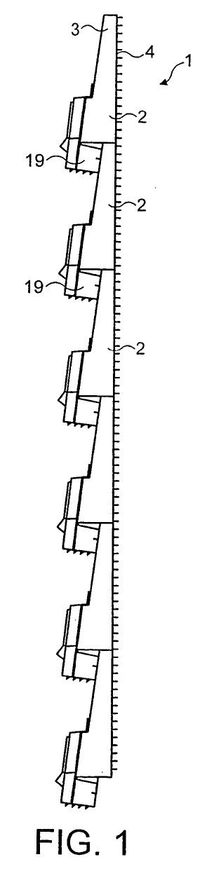

FIG. 1 is a cross-sectional side view of a display according to the invention;

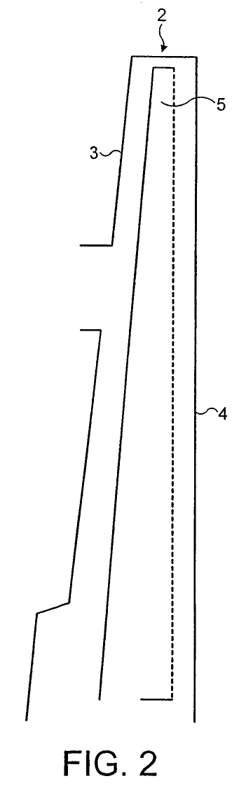

FIG. 2 is a cross-sectional side view of a module of the display of FIG. 1;

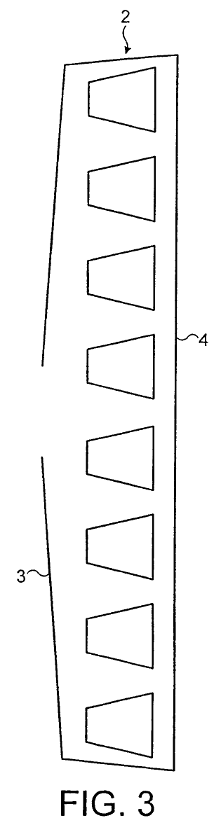

FIG. 3 is a cross-sectional plan view of the module of FIG. 2;

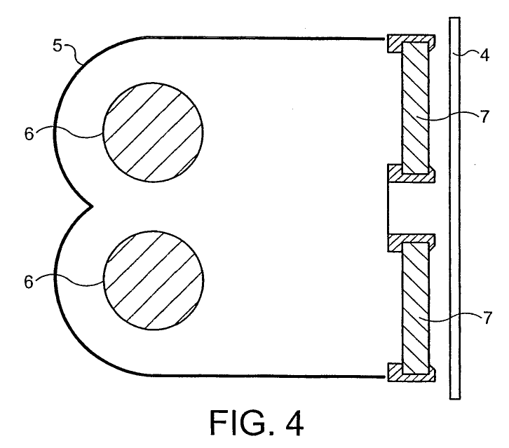

FIG. 4 is a cross-sectional plan view of a reflector unit of the module of FIGS. 2 and 3;

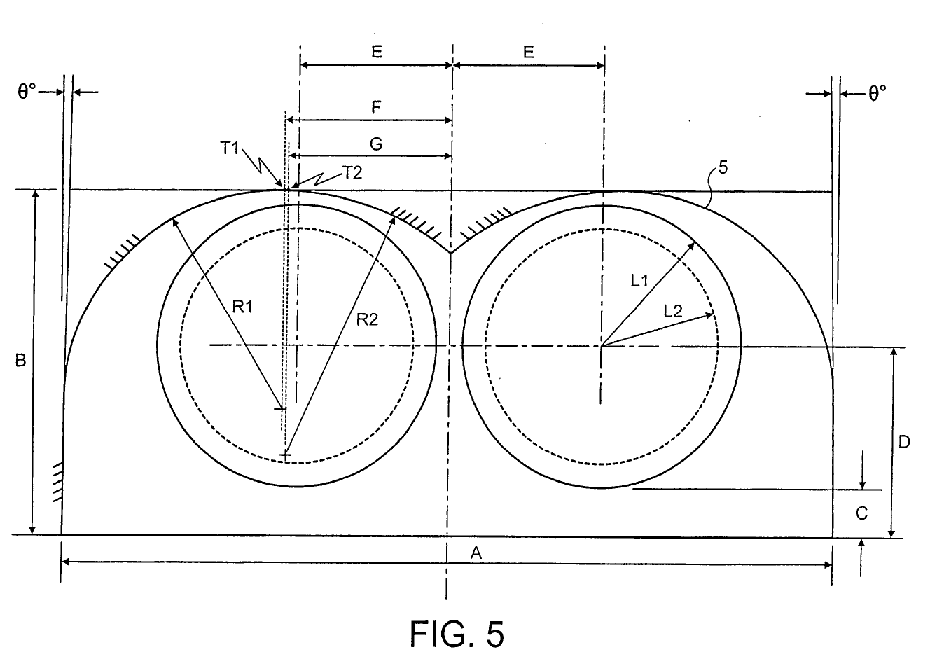

FIG. 5 is another cross-sectional plan view of the reflector unit of FIG. 4 showing the relative dimensions of the unit;

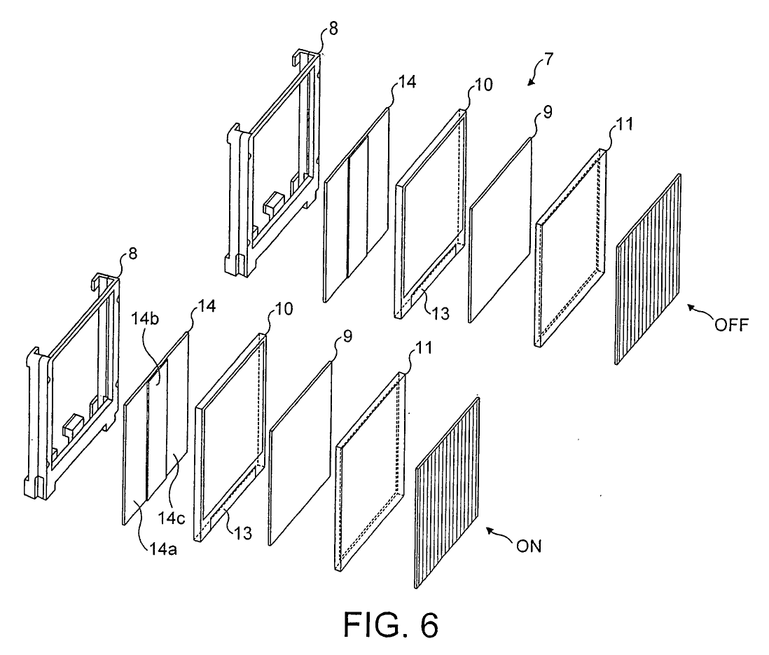

FIG. 6 is an exploded perspective view of a liquid crystal element of the display of FIG. 1;

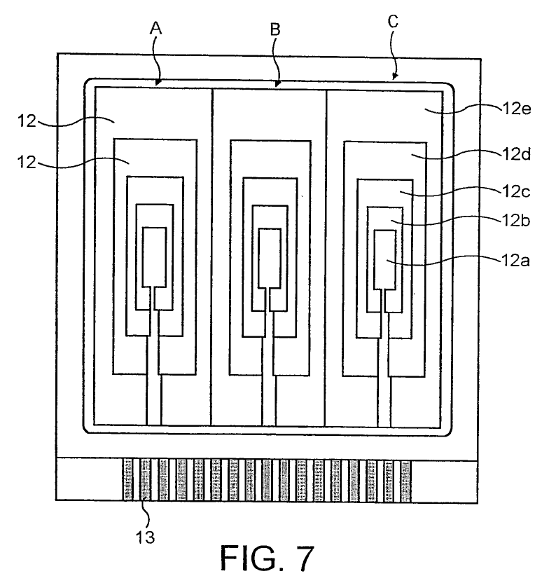

FIG. 7 is a front view of the liquid crystal element of FIG. 6;

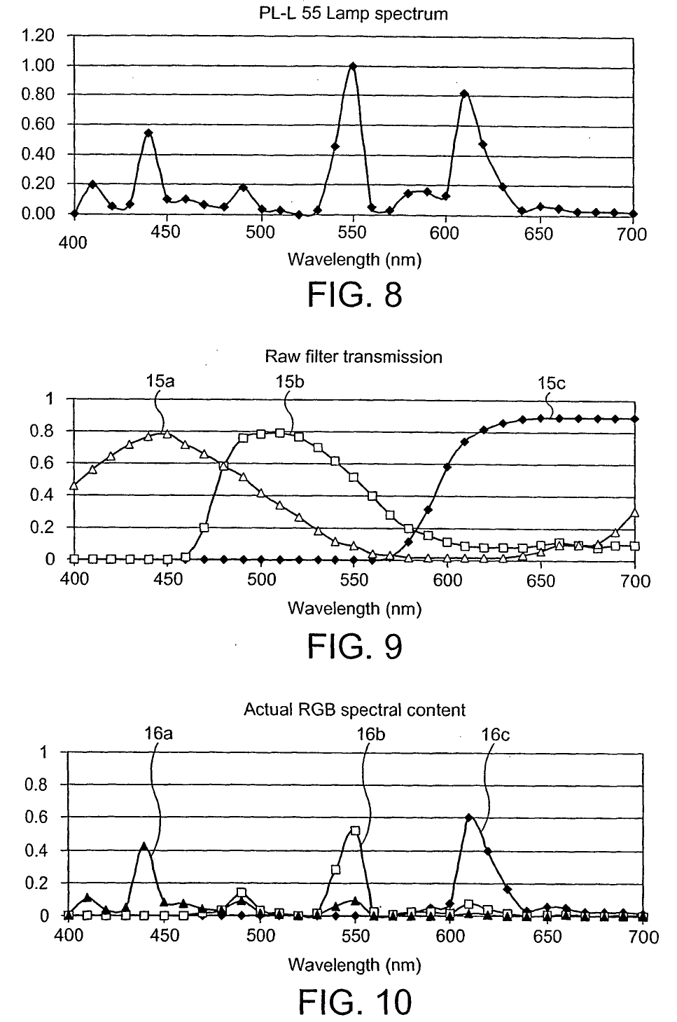

FIG. 8 is a graphical illustration of the emission spectrum of a lamp of the display of FIG. 1;

FIG. 9 is a graphical illustration of the transmission characteristics of red, green a blue filters of the display of FIG. 1;

FIG. 10 is a graphical illustration of the light output of the display of FIG. 1;

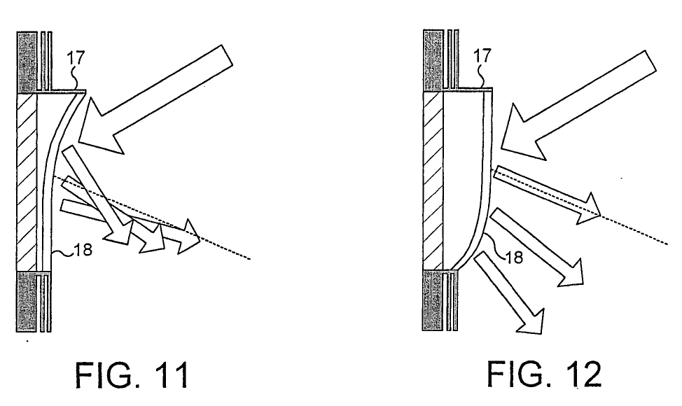

FIG. 11 is a cross-sectional side view of an anti-glare screen of the display of FIG. 1;

FIG. 12 is a cross-sectional side view of an alternate anti-glare screen of the display of FIG. 1;

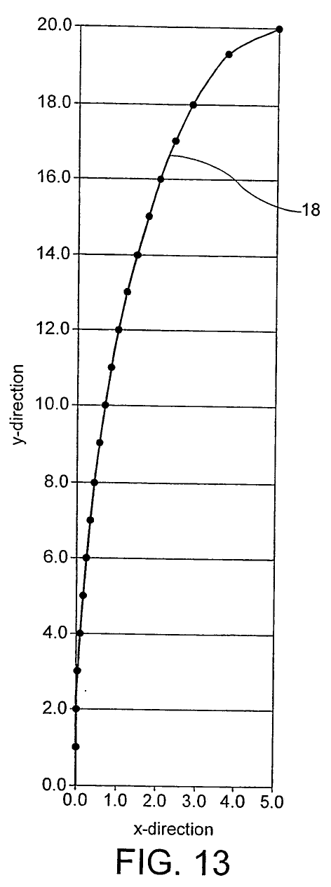

FIG. 13 is a graphical illustration of the curvature of the front surface of the screen of FIG. 11;

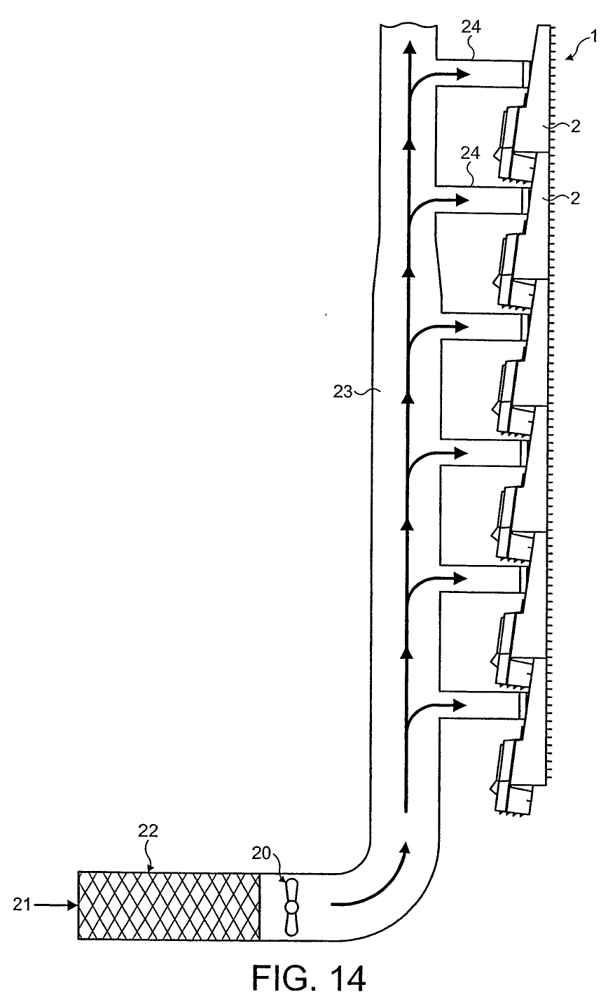

FIG. 14 is a cross-sectional side view of the display of FIG. 1 showing an air cooling system;

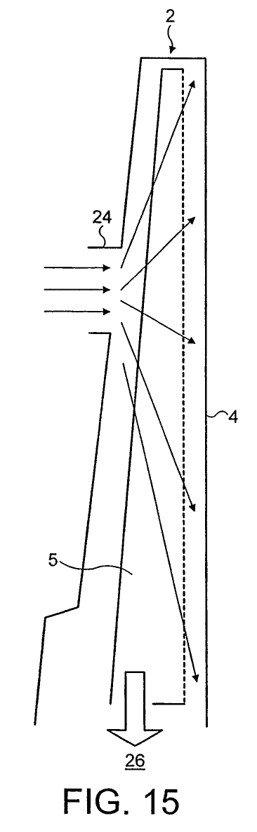

FIG. 15 is a cross-sectional side view of the module of FIG. 2 showing the air cooling system;

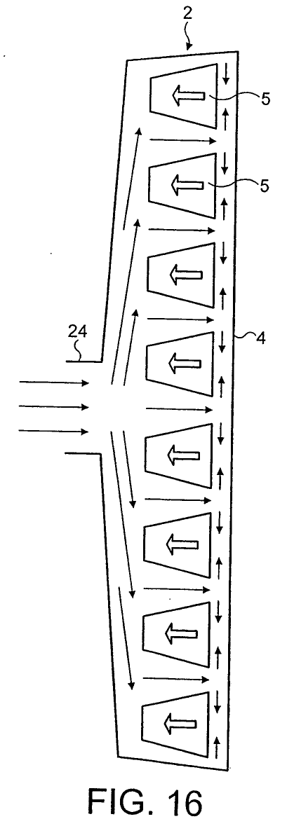

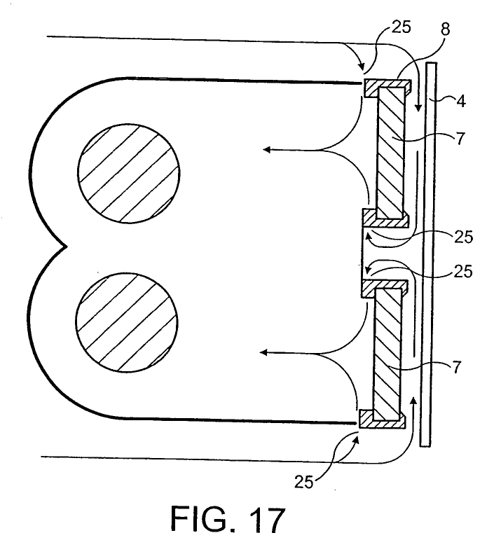

FIG. 16 is a cross-sectional plan view of the module of FIG. 2 showing the air cooling system;

FIG. 17 is a cross-sectional plan view of the reflector unit of the FIG. 4 showing the air cooling system;

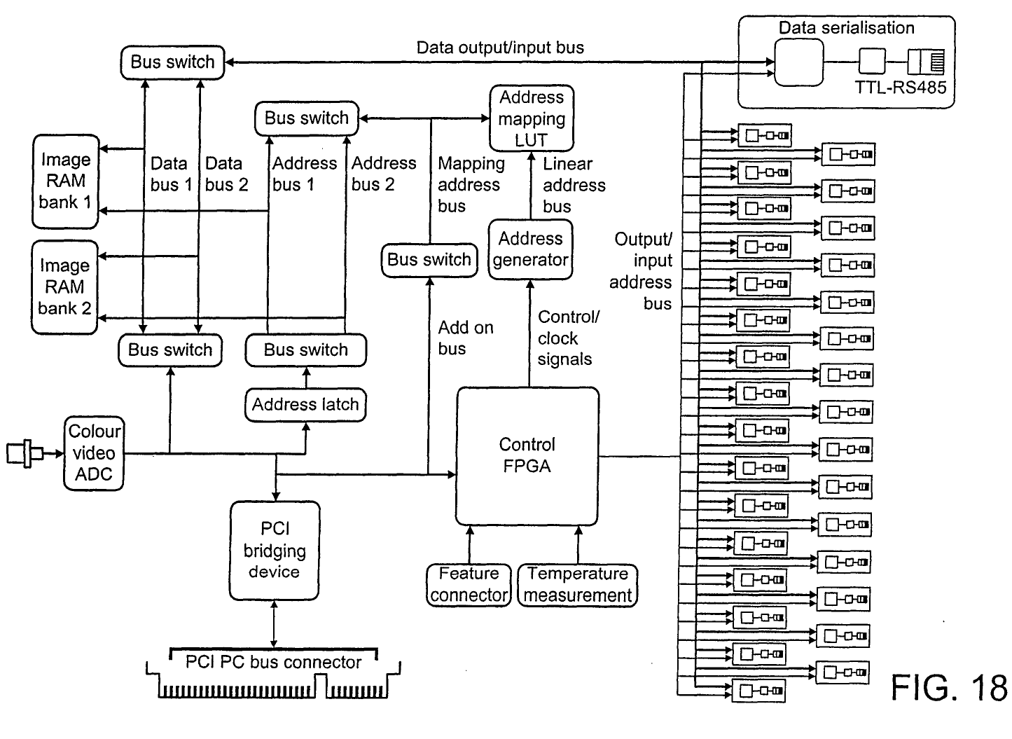

FIG. 18 is a schematic illustration of a control system of the display of FIG. 1;

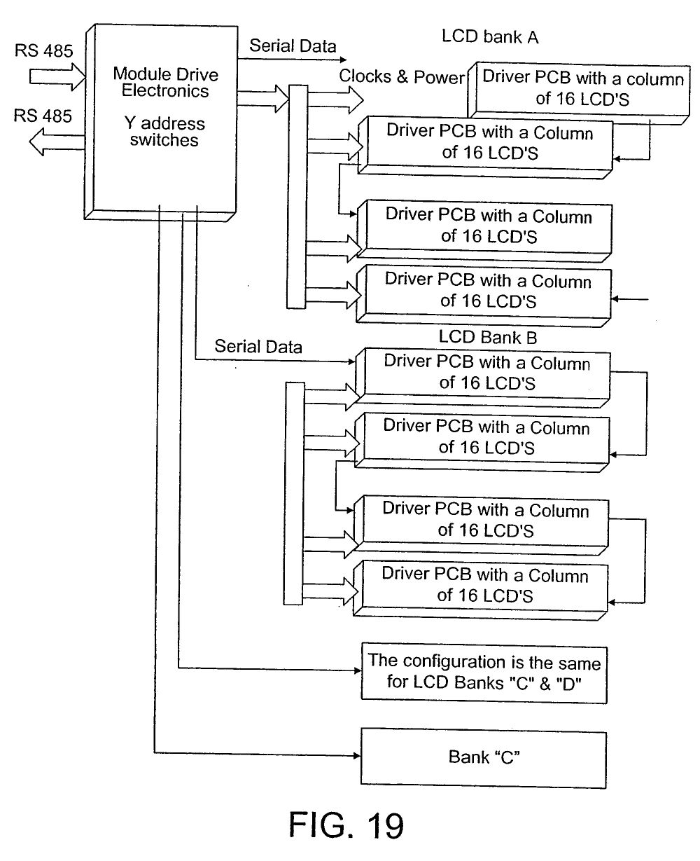

FIG. 19 is a schematic illustration of the drivers of the control unit of FIG. 16; and

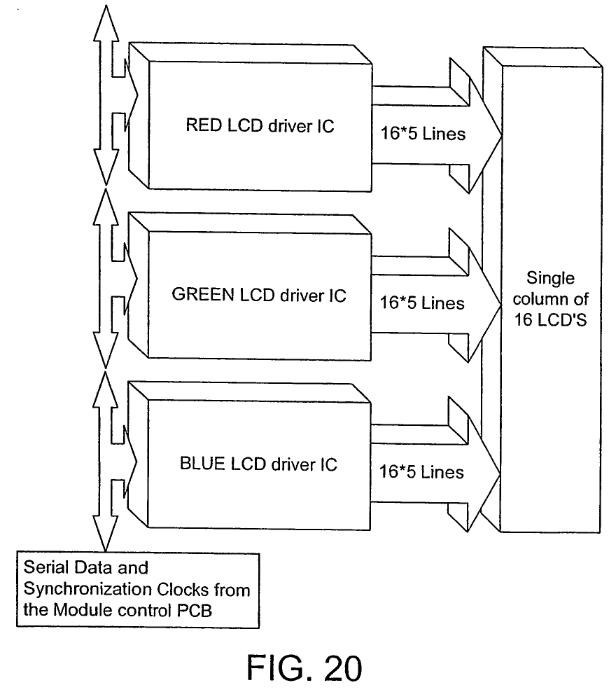

FIG. 20 is a schematic illustration of the drivers for a column of pixels of the module of FIG. 2.

Embodiments of the invention are described below in relation to a large screen display for outside use. However, it will be apparent to the skilled man that various aspects of the invention may be of use in other applications and that the display described below may be modified to suit particular applications. For example, the size of the display may vary according to the requirements of a particular application or location. Likewise, the display may be adapted for indoor use if desired.

Referring to FIGS. 1 to 4, a display 1 comprises an array of display modules 2. Each module 2 comprises a housing 3 and a transparent front screen 4. Each module 2 houses a reflector 5 which, in turn, houses a lamp 6. Mounted on the front of each reflector 5 are liquid crystal elements 7.

The modules 2 are generally wedge shaped. In this example the wedge shape tapers by 7°. The bottom, thick end of each module 2 mates with a lamp cartridge 19. Each lamp cartridge 19 has fittings for eight lamps 6. In this example, the lamps 6 are U-shaped fluorescent tubes and more specifically Phillips® PL-L 55 W dual tube fluorescent lamps. With the lamps 6 in place, each lamp cartridge 19 has eight U-shaped fluorescent tubes extending from it. This provides sixteen elongate light sources. The cartridge 19 mates with the housing 3 of the module 2 such that, when in position, the lamps 6 carried by the cartridge 19 extend into the housing 3 of the module 2 roughly parallel to the rear wall of the housing 3, i.e. to the wall opposite the transparent front screen 4.

There are eight reflectors 5 mounted in a module 2 and, when in position, each lamp 6 fits inside one of the reflectors 5. As seen in FIG. 2, each reflector 5 is generally wedge shaped along its length, such that its rear surface is parallel with the rear surface of the housing 3 and its front face is parallel with the screen 4. Thus, in this example, the reflectors taper by around 7°, i.e. by the same angle as the modules 2.

As seen in FIGS. 4 and 5, the reflectors 5 are generally W-shaped in cross-section and have open front faces. Each half or U-shape of the base of the W-shape reflectors 5 follows the circumference of two arcs, having radii R1 and R2 respectively. The arcs are centred at positions T1 and T2 respectively, forward of the centre of each of the tubes of the lamp 6 positioned in the reflector 5. The curved rear surface of the reflector 5 follows the following profile: from a first side wall along a first arc having radius R1 centred on point T1; along a second arc R2 centred on point T2; then along a mirror image of the first and second arcs and first side wall, the image being reflected about a plane perpendicular to the front opening of the reflector 5 and equidistant from the centre of each of the fluorescent tubes of the lamp 6. The sides of the reflector 5 are substantially parallel to one another and perpendicular to the open front face of the reflector 5 and the front screen 4. However, in practice, it has been found useful for the sides to be angled outwardly by around 1° to aid removal of the reflectors 5 from their moulds during manufacture.

Referring to FIG. 5, the dimensions of the reflector 5 in this example are:

| DIMENSION | SIZE | |
|---|---|---|
| Front face width (A) | 50 | mm |
| Minimum reflector depth (B) | 22 | mm |
| Minimum lamp face to front | 3 | mm |
| face distance (C) | | |
| Minimum lamp centre to | 12 | mm |
| front face (D) | | |
| Lamp centre to reflector | 10 | mm |
| centre (E) | | |
| Tangent point T1 (for R1) | 11 | mm |
| to reflector centre (F) | | |
| Tangent point T2 (for R2) | 10.95 | mm |
| to reflector centre (G) | | |
| Tube outer diameter (L1) | 18 | mm |
| Tube inner diameter (L2) | 15 | mm |
| Outside arc radius (R1) | 14 | mm |
| Inside arc radius (R2) | 17 | mm |
| Side wail angle θ | 1° | |

The inner surfaces of the reflectors 5 are coated with a highly reflective material to maximise the intensity of the light transmitted out of the reflectors 5. In this example 3M Visible Mirror® is used, which provides 98% efficient reflection. The profile of the reflectors 5 minimise the number of internal reflections before light leaves the reflectors 5 and the light intensity is thus maximised.

Referring to FIG. 6, the liquid crystal elements 7 are mounted on the open front face of the reflectors 5. In this example, two columns of sixteen liquid crystal elements 17 are mounted on each reflector 5. Thus, each module 2 comprises an array of sixteen by sixteen, i.e. 256, liquid crystal elements 7. The liquid crystal elements 7 are approximately 20 mm by 20 mm. This has been found to offer sufficient resolution for most large screen display applications.

Each liquid crystal element 7 comprises a clip 8 for housing a liquid crystal device and mounting it to a reflector 5. The clips 8 comprise two square frames 8a, 8b connected by hinges along one edge. Liquid crystal 9 is sandwiched between two glass plates 10 and 11. On one of the glass plates 10 are provided electrodes 12 and connectors 13. The electrodes 12 effectively divide the liquid crystal 9 into segments having shapes identical to those of the electrodes 12.

As can be seen in FIG. 6, the electrodes comprise three groups A, B, C, each group A, B, C of electrodes 12 being arranged side-by-side and the electrodes 12 of each group A, B, C being concentric to one another. The smallest electrode 12a of a group A is rectangular. The next largest electrode 12b is twice the size of electrode 12a, i.e. has a surface area twice that of electrode 12a, and is arranged around the perimeter of the rectangular electrode 12a. Likewise, the third largest electrode 12c has twice the surface area of the second largest electrode 12b and is arranged around the outside of electrode 12b. Five electrodes 12a to 12e are provided in each group A, B, C of electrodes 12 and the electrodes 12a to 12e increase in size with respect to one another by a factor of 2. This allows a binary scaling of the surface area of liquid crystal 9 operated on by a group of electrodes A, B, C.

The liquid crystal 9 is a Helmeier type liquid crystal. In other words, the liquid crystal 9 comprises a nematic material, i.e. a liquid crystal whose molecules alter orientation when in an electric field and a pleochroic dye that absorbs light having particular polarisation according to the direction in which the molecules of the dye are oriented. In this example, three pleochroic dyes are added to the liquid crystal such that the liquid crystal can absorb light in the red, green and blue colour parts of the light spectrum. These are combined Merck GmbH dye ZL1-4714/3. The host nematic material is ZL1-3950 with a dye concentration of 3%.

Colour filters 14 are provided on the outer surface of the glass 10. The colour filters 14 comprise gel filters and are glued to the surface of the glass plate 10 using a glue having similar or the same refractive index as the glass plate 10. In this example, Rosco® SG19, Rosco® SG389 and Rosco® SG69 gel filters are used as red, green and blue filters respectively. The colour filters 14 are arranged on the glass 10 such that each filter covers the area of a group A, B, C of electrodes 12. Thus, light passing through group A of electrodes 12 also passes through the red filter 14a, light passing through the group B of electrodes 12 also passes through the green filter 14b and light passing through the third group C of electrodes 12 also passes through the blue filter 14c.

A polarising material is provided on the outer surface of the glass plate 11. The polarising material is a linear absorption polariser oriented vertically. As most Polaroid® sunglasses have polarising filters that are also oriented vertically, this reduces viewing problems for viewers wearing Polaroid sunglasses.

Referring the FIGS. 8 to 10, the Philips® PL-L55 lamp can be seen to emit light in three distinct sections of the electromagnetic spectrum. A blue component of the light emitted by the lamp 6 is centred around 435 nanometres. A green component of light emitted by the lamp 6 is centred around 545 nanometres and a red component of light emitted by the lamp 6 is centred around 610 nanometres. The red, green and blue filters 14a, 14b, 14c each transmit light centred roughly around the same wavelength. Referring to FIG. 9, the blue filter transmits light as shown by the curve 15a, the green filter transmits light as shown by the curve 15b and the red filter transmits light as shown by the curve 15c. This has the result that light emitted by the lamp 5 is transmitted by the filters 14a, 14b, 14c as shown by the curves 16a, 16b, 16c in FIG. 9 respectively. As can be seen from FIG. 9, light in each of the strong emission peaks of the Philips PL-L55 lamp is transmitted by the filters 14 without significant loss. This maximises the useful light output of the lamp 5.

Nevertheless, in outdoor situations light reflected by the front surface of the screen 4 can significantly deteriorate the image displayed by the display 1. The transparent screen 4 of the display 1 therefore has louvres 17 provided on its forward facing surface, i.e. that facing away from the lamps 5. The louvres 17 comprise strips of opaque material fixed horizontally across the screen 4 and which extend perpendicularly from the forward facing surface. The front of the transparent screen 4 therefore resembles a Venetian blind with the slats tilted horizontally. Light incident on the front of the screen 4 is therefore absorbed by the louvres and the amount of light arriving at the transparent front surface 15 of the screen 4 is therefore reduced.

The louvres 17 extend away from the screen 4 by an amount selected according to the position in which the display 1 is installed. In an installation where ambient light, such as the sun, is incident on the screen from only high angles, the louvres 17 are approximately 5 mm in width. In installations where ambulant light is incident on the screen from lower angles, the louvres 17 may be approximately 10 mm, 20 mm, 30 mm or 40 mm in width. The following table gives an indication of the suitable width of louvres 17.

| | MAXIMUM | MAXIMUM AMBIENT |
|---|---|---|
| WIDTH | VIEWING ANGLE | LIGHT ILLUMINATION |
| OF LOUVRE | FROM HORIZONTAL | ANGLE FROM VERTICAL |
| 5 mm | 63° | 14° |
| 10 mm | 45° | 27° |
| 20 mm | 27° | 45° |
| 30 mm | 18° | 56° |
| 40 mm | 14° | 63° |

However, it is not possible to entirely prevent ambient light from being incident on the front surface of the transparent screen 4. In addition, the screen 4 therefore has a contoured front surface 18. The contour from top to bottom of the screen follows plural curves repeated between each of the louvres 14. The screen 4 has uniform cross-section across its width. Light incident on the curved surface 18 is dispersed by the curvature of the surface 18 and deterioration of the image transmitted through the screen 4 by the lamps 5 is therefore reduced.

Referring to FIG. 10A, in one example the curvature of the front face 15 of the screen 4 is concave. Referring to FIG. 10B, in another example the curvature of the front surface of the screen is convex. In the case of a concave surface, it has been found that the contour of the circumference of an ellipse is most effective. Referring to FIG. 13, the optimum surface follows

$$y = √ ( ( 1 - \frac{{x}^{2}}{{a}^{2}} ) {b}^{2} )$$

where x is a direction in the plane of the screen, y is a direction out of the plane of the screen, a is 20 and b is 4.

Referring to FIG. 14, the display 1 has a cooling system comprising a fan 20 for sucking air through an inlet 21 and filter 22 and providing air under pressure to the modules 4 through an air duct 23. The air duct 23 is tapered such that air pressure in the duct 23 remains roughly constant along its length. However this taper is not essential. Air passes from the duct 23 through module ducts 24 to the back of the housing 3 of the modules 2. Referring to FIGS. 15 and 16, when the air enters the modules 2 through the module ducts 24, it passes around the outside of the reflectors 6 to the screen 4 at the front of the module 2. Printed circuit boards (PCBs) (not shown) for controlling the liquid crystal elements 7 are provided on the outside surfaces of the reflectors 6. As the air passes between the reflectors 5 it therefore passes over the PCBs and cools them. The air then passes into the gap between the screen 4 and liquid crystal elements 7. Gaps 25 are provided around the outside of the clips 8 of the liquid crystal element 7 such that air can pass across the surface of the liquid crystal element 7 and into the cavity defined by the reflectors 5 and liquid crystal elements 7. As air passes across the surface of the liquid crystal elements, the liquid crystal elements are cooled. The air then passes around the lamps 6 and down the cavity to an exit port 26 in the bottom of each reflector 5. The liquid crystal elements 7 operate in a desired temperature range between 10° C. and 35° C. The surface of the lamp tubes should be maintained between 75° C. and 90° C. The gaps 25 provided by the clips 8 of the liquid crystal elements 7 are 0.5 mm wide and have a surface area adapted to provide air flow to maintain the temperatures of the liquid crystal elements and the lamps 6 within their desired ranges.

It may be seen form the above that an embodiment of the invention comprises an array of enclosed LCD modules which have a lensed acrylic face enclosing a matrix of 256 individual Helmeier type (guest host) LCD's which are laminated with red, green and blue colour filters enabling the peak emission wavelengths of fluorescent lamps to be shuttered for displaying a moving image or such like on a large, e.g. outdoor, screen.

1-45. (Canceled).

46. A display screen comprising a plurality of pixels arranged in rows and an anti-glare screen arranged over the pixels comprising anti-glare elements having a surface facing a position from which the display screen is viewable, which surface is curved to disperse light incident on the screen, wherein said anti-glare elements are arranged line-by-line over said rows of pixels.

47. A display screen as claimed in claim 46, wherein the curved surface of each element has a length of similar dimensions to a pixel of the screen, with anti-glare elements being provided over each pixel.

48. A display screen as claimed in claim 46, wherein the surfaces of the anti-glare elements are concave.

49. A display screen as claimed in claim 46, wherein the surfaces of the anti-glare elements are convex.

50. A display screen as claimed in claim 46, wherein the surfaces of the anti-glare elements have the shape of a section of the circumference of a conic section.

51. A display screen as claimed in claim 50, wherein the surfaces of the anti-glare elements have a substantially parabolic shape.

52. A display screen as claimed in claim 50, wherein the surfaces of the anti-glare elements have the shape of a section of the circumference of an ellipse.

53. A display screen as claimed in claim 46, wherein each pixel is square and has an area of between 49 mm² and 2500 mm².

54. A display screen as claimed in claim 46, wherein the screen has a total area of 3 m² to 120 m².

55. A display screen as claimed in claim 46 further comprising a plurality of pixel modules arranged such that the mutual spacing between said pixels is substantially constant so as to give a substantially seamless image.

56. A display screen comprising a plurality of pixels, wherein the pixels comprise liquid crystal elements divided into segments and the brightness of light passing through a respective pixel can be varied by controlling the number of segments of liquid crystal that are substantially transparent or substantially opaque.

57. A display screen as claimed in claim 56, comprising means of varying the relative proportions of time for which said segments are substantially transparent and substantially opaque respectively.

58. A display screen as claimed in claim 56, wherein the liquid crystal elements are Helmeier type liquid crystal.

59. A display screen as claimed in claim 58, wherein the Helmeier liquid crystal elements comprise a linear polariser and a nematic liquid hosting a pleochroic or Azo dye.

60. A display screen as claimed in claim 56, wherein said pixels comprise segments having differing surface areas.

61. A display screen as claimed in claim 60, wherein the surface areas of the segments are related to one another by powers of 2.

62. A display screen as claimed in claim 56, wherein each pixel comprises segments arranged concentrically.

63. A display screen as claimed in claim 56, wherein each pixel comprises segments having surface areas which increase toward the periphery of each pixel.

64. A display screen according to claim 60, wherein each pixel has red, green and blue filters and the filters are provided over groups of segments of each pixel such that the brightness of each colour may be varied.

65. A display screen according to claim 56, further comprising a white light source and filters for altering the colour of light transmitted by the or each pixel, wherein the filters have a band of strongest transmission at a wavelength substantially equal to an emission peak of the light source.

66. A display screen as claimed in claim 65, wherein dye provided in the pixels is also selected to absorb strongly at emission peaks of the light source.

67. A display screen as claimed in claim 56, wherein each pixel is square and has an area of between 49 mm² and 2500 mm².

68. A display screen as claimed in claim 56, wherein the screen has a total area of 3 m² to 120 m².

69. A display screen as claimed in claim 56 further comprising a plurality of pixel modules arranged such that the mutual spacing between said pixels is substantially constant so as to give a substantially seamless image.

70. A display comprising a display screen having a plurality of pixels, said display screen being arranged to be illuminated from the rear, the illumination comprising a plurality of tubular light sources inclined along their length to the plane of the display screen.

71. A display as claimed in claim 70, wherein the angle of inclination is about 8°.

72. A display as claimed in claim 70, wherein said white light source is a fluorescent tube having a U-shape.

73. A display as claimed in claim 70, wherein each pixel is square and has an area of between 49 mm² and 2500 mm².

74. A display as claimed in claim 70, wherein the screen has a total area of 3 m² to 120 m².

75. A display as claimed in claim 70, wherein a temperature management system supplies air to the pixels.

76. A display as claimed in claim 70 comprising a reflector having a first arc of curvature along the base from the sidewall and a second arc of curvature along the base from a position intermediate to the light sources in use.

77. A display as claimed in claim 70 comprising a plurality of pixel modules arranged such that the mutual spacing between said pixels is substantially constant so as to give a substantially seamless image.
